(19) United States
(12) Patent Application Publication
(10) Pub. No.: US 2004/0178614 A1
(43) Pub. Date: Sep. 16, 2004

(54) Inflatable lap belt safety bag

(76) Inventors: Kevin S. Countryman, Mesa, AZ (US); Kevin J. Keeslar, Chandler, AZ (US); Robert C. Lazaroff, Chandler, AZ (US)

Correspondence Address: Daniel H. Shulman, Mayer, Brown, Rowe & Maw, P.O. Box 2828, Chicago, IL, 60690-2828, US

(21) Appl. No.: 10/389,405

(22) Filed: Mar. 14, 2003

(51) Int. Cl. B60R 21/16

(52) U.S. Cl. 280/743.1

(57) ABSTRACT

An inflatable lap belt safety bag comprising: a first fabric piece comprising two sides thereof and two ends thereof, wherein the two ends thereof are secured to the lap belt in the vicinity of an inflation source, wherein the first fabric piece is constructed to define a top, bottom, front and rear panels of the safety bag; a pair of side fabric pieces attached to opposite sides of the first fabric piece to define a pair of opposite side panels of the safety bag; and wherein each of the side fabric pieces comprises a first portion, a second portion and an intermediate portion, and wherein the intermediate portion has a smaller width than the first and second portions.

### BACKGROUND OF THE INVENTION

1. Field of the Invention

The present invention relates to an inflatable lap belt safety bag. Particularly, the present invention is directed to an inflatable lap belt safety bag which provides improved safety characteristics.

2. Description of Related Art

Inflatable safety bags are known in the art. In some applications, these safety bags may be connected to a lap belt and an inflation source thereabout to provide for an inflatable lap belt safety bag. The safety bags are generally operable through electronics which couple an inflation activation system to a deceleration sensor circuitry. Thus, when a deceleration characteristic of an impact event occurs, a signal is sent to the activation system. The activation system activates an inflation source which inflates a bag of air to provide a cushion for the user in the event of an impact.

Such conventional methods and systems generally have been considered satisfactory for their intended purpose. However, there are disadvantages to the known systems. Specifically, the known systems utilize what is essentially a single chamber air bag that is inflated completely upon activation. These air bags provide cushioning for the entire body at one, torso and head included. However, the kinematics of the torso and the head may be different during an impact event. Thus, a need exists in the art for an air bag that accounts for these kinematic differences. Particularly necessary is an air bag that operates on the torso/abdomen area in a first stage to slow the entire body, and the operates on the head during a second stage.

### SUMMARY OF THE INVENTION

The purpose and advantages of the present invention will be set forth in and apparent from the description that follows, as well as will be learned by practice of the invention. Additional advantages of the invention will be realized and attained by the methods and systems particularly pointed out in the written description and claims hereof, as well as from the appended drawings.

To overcome the disadvantages of the prior art, a unique lap belt safety bag is provided. The safety bag according to preferred embodiments of the present invention is characterized in that it comprises a first portion, an intermediate portion, and a second portion. The air bag is further characterized in that the intermediate portion has a reduced width with respect to the first and second portions, thus acting as a “bottleneck” for inflation of the second portion. According to the preferred embodiments, therefore, the first portion is inflated upon activation and cushions the torso/abdomen of the user. As the user's inertia forces the user's body forward, the user is decelerated, and air from the first portion is pushed through the intermediate portion to the second portion, which is continuing to inflate with air from the inflation source. The inflation of the second portion then cushions the head, which has had its deceleration rate reduced by the interaction of the first portion and the torso/abdomen as a whole.

To achieve these and other advantages and in accordance with the purpose of the invention, as embodied and broadly described, an embodiment of the invention includes an inflatable lap belt safety bag comprising a first inflatable end, an intermediate section and a second inflatable end, wherein the intermediate section has a reduced cross section relative to the first and second inflatable ends to limit inflation of the second inflatable end until after inflation of the first inflatable end.

According to yet another embodiment of the invention, the invention comprises an inflatable lap belt safety bag comprising: a first fabric piece comprising two sides thereof and two ends thereof, wherein the two ends thereof are secured to the lap belt in the vicinity of an inflation source, wherein the first fabric piece is constructed to define a top, bottom, front and rear panels of the safety bag; a pair of side fabric pieces attached to opposite sides of the first fabric piece to define a pair of opposite side panels of the safety bag; and wherein each of the side fabric pieces comprises a first portion, a second portion and an intermediate portion, and wherein the intermediate portion has a smaller width than the first and second portions.

It is to be understood that both the foregoing general description and the following detailed description are exemplary and are intended to provide further explanation of the invention claimed.

The accompanying drawings, which are incorporated in and constitute part of this specification, are included to illustrate and provide a further understanding of embodiments of the invention. Together with the description, the drawings serve to explain the principles of the invention.

### BRIEF DESCRIPTION OF THE DRAWINGS

FIG. 1 is a an inflated lap belt safety bag in accordance with an embodiment of the invention.

FIG. 2 is a cross section of a portion of the lap belt safety bag of FIG. 1 taken along line 2-2.

FIG. 3 is an exploded view of a lap belt safety bag in accordance with an embodiment of the invention.

FIG. 4 is a partial cutaway side view of an inflated lap belt safety bag in accordance with an embodiment of the invention.

FIG. 5 is a cross section of the lap belt safety bag of FIG. 4 taken along line 5-5.

FIG. 6 depicts a user of the lap belt safety bag of the present invention prior to an impact event.

FIG. 7 depicts a user of the lap belt safety bag of the present invention just after an impact event.

FIG. 8 depicts a user of the lap belt safety bag of the present invention just after the moment depicted in FIG. 7.

FIG. 9 depicts a user of the lap belt safety bag of the present invention just after the moment depicted in FIG. 8.

FIG. 10 depicts a user of the lap belt safety bag of the present invention just after the moment depicted in FIG. 9.

FIG. 11A is a cross sectional view of the lap belt just prior to an inflation event.

FIG. 11B is a cross sectional view of the lap belt just immediately following an inflation event.

FIG. 11C is a cross sectional view of the lap belt after inflation.

### DETAILED DESCRIPTION OF THE PREFERRED EMBODIMENT

Reference will now be made in detail to the present preferred embodiments of the invention, examples of which are illustrated in the accompanying drawings. The method and corresponding steps of the invention will be described in conjunction with the detailed description of the system.

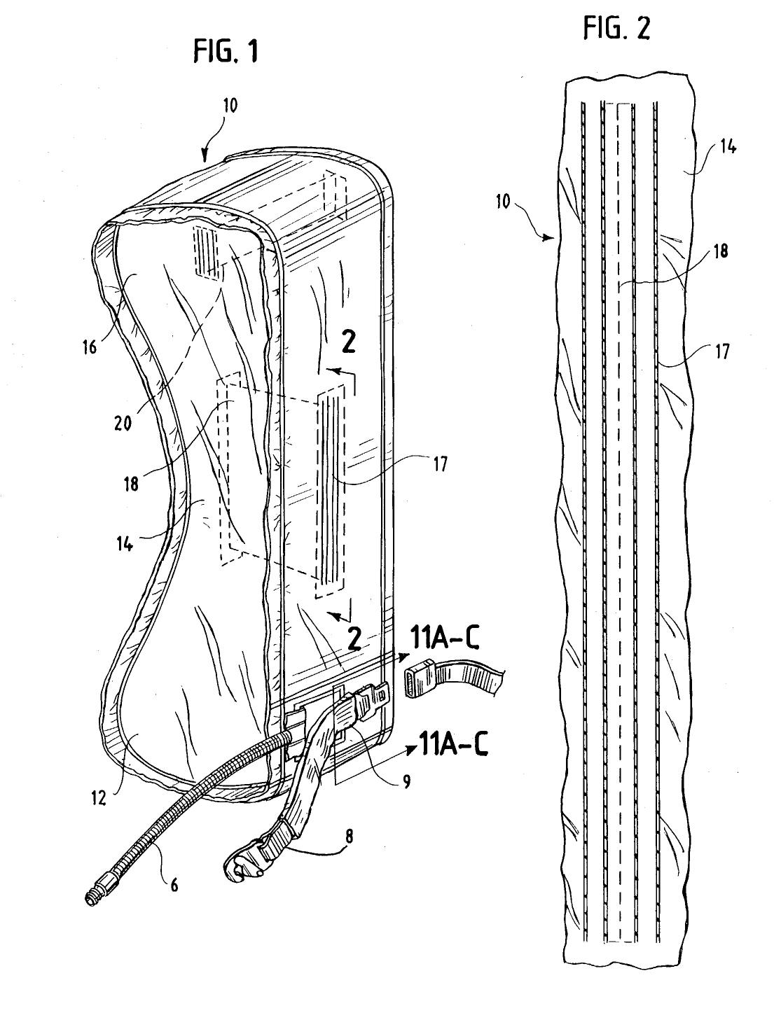

For purpose of explanation and illustration, and not limitation, an exemplary embodiment of the system in accordance with the invention is shown in FIG. 1 and is designated generally by reference character 10. The lap belt safety bag 10 comprises a first inflatable end 12, an intermediate portion 14, and a second inflatable end 16. The first inflatable end 12 is connected to an inflation source (not shown) via a gas transmission device 6, such as a hose, and is, in its deflated mode, housed in a cover 9 on the lap belt 8. The inflation source is coupled to a deceleration sensor circuitry (not shown) which, upon detection of a deceleration event characteristic of an impact, will operate to inflate the bag 10 via the hose 6. Upon the requisite degree of inflation, as shown in FIGS. 11A-C, the tear seam portion 82 of the cover 81 of the belt housing 9 housing the bag 10 will tear open in a controlled manner. The size of the bag depends upon the construction of the vehicle for which the bag is being used. In an airplane, for example, where there is typically 30-33 inches between seats, the fully inflated bag is approximately 30-34 inches high. It is to be understood, however, that other dimensions may also satisfy the invention. The bag 10 may also comprise internal tethers 18 and 20, as will be explained in more detail below.

As shown in FIGS. 1-5, the internal tether 18 is provided connecting the front panel 102 and rear panel 104 of fabric piece 100 of the safety bag 10 between the intermediate portions 114a, 114b. In the preferred embodiment, the tether 18 comprises a single piece of fabric stitched at one end 17a to the rear panel 104, then looped and stitched to itself 15a. The stitching is similarly provided for at the front panel 102. The tether helps ensure that the width of the intermediate portion 14 (wᵢ) is reduced with respect to widths of the first inflatable end 12 (w₁) and second inflatable end 16 (w₂). Thus, the intermediate portion 14 serves as a “bottleneck,” delaying inflation of the second inflatable end 16. The tether 18 is preferably made of polyester or nylon, but is not restricted to those materials. An additional tether 20 may be provided and similarly stitched to prevent ballooning of the side panels 111a, 111b at locations 116a, 116b.

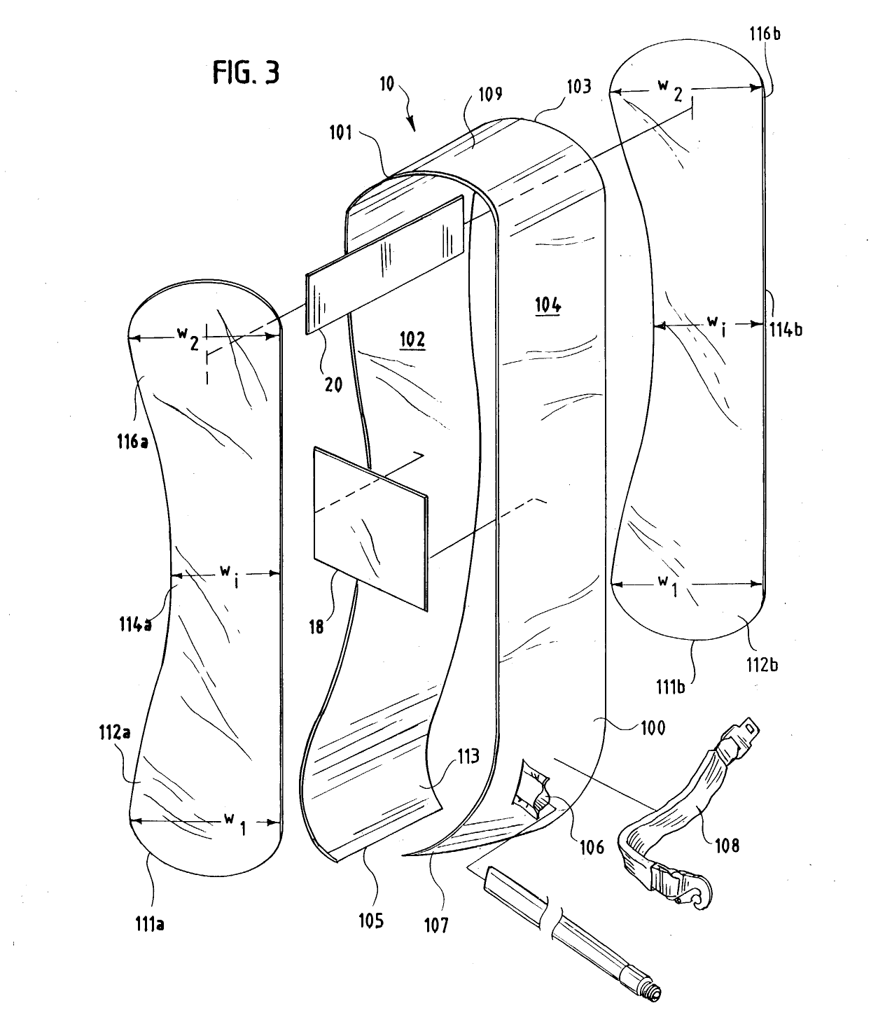

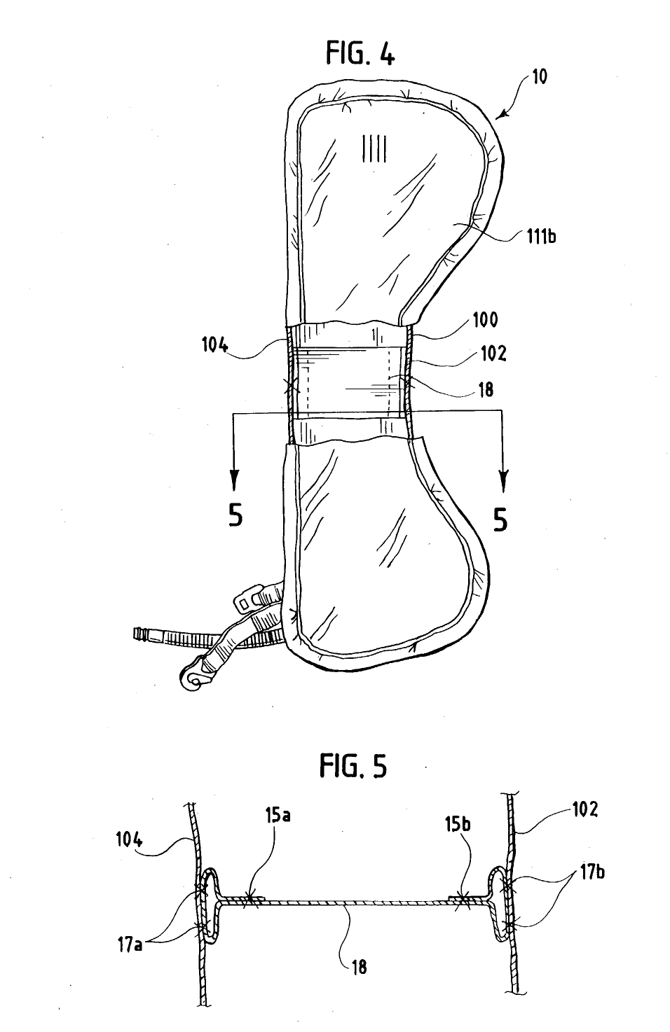

As seen in FIG. 3, the bag 10 as a whole is typically constructed using three fabric pieces. A first fabric piece 100 is provided comprising two sides thereof 101, 103 and two ends thereof 105, 107, wherein the two ends thereof 105, 107 are secured to the lap belt in the vicinity of an opening or duct 106. The first fabric piece 100 is constructed to define a top 109, bottom 113, front 102 and rear panels 104 of the safety bag 10. The bag 10 further comprises a pair of side fabric pieces 111a, 111b attached to opposite sides 101, 103 of the first fabric piece 100 to define a pair of opposite side panels of the safety bag. Each of the side fabric pieces 111a, 111b comprises a first portion 112a, 112b, a second portion 116a, 116b and an intermediate portion 114a, 114b. The intermediate portions 114a, 114b each have a smaller width wᵢ than the widths of the first and second portions, w₁ and w₂. As best seen in FIG. 4, the inflated lap belt safety bag 10 has the general shape of the capital letter “B,” with a substantially flat rear side 104 and an indentation in the front side 102. The bag 10 is preferably made of nylon or polyester, although any material that is lightweight and tear-resistant will be satisfactory. In addition, the three fabric pieces 100, 111a and 111b are stitched together at the seams using, for example, chain stitch or lock stitch, with a nylon or Kevlar thread. Other stitchings and materials known in the art may also be suitable. The three-piece construction described herein is the simplest, but by no means only, means of constructing the present airbag. Alternative constructions may use more or less fabric pieces, so long as the overall “B” shape of the bag provided by the reduced width of the intermediate section 14 is maintained.

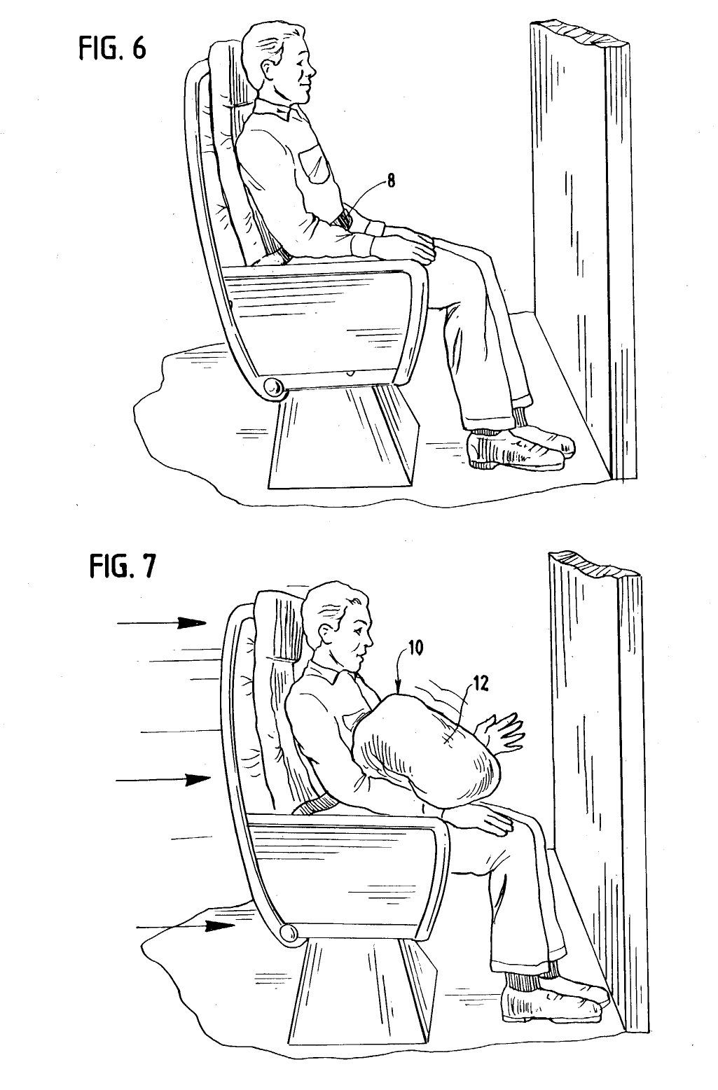

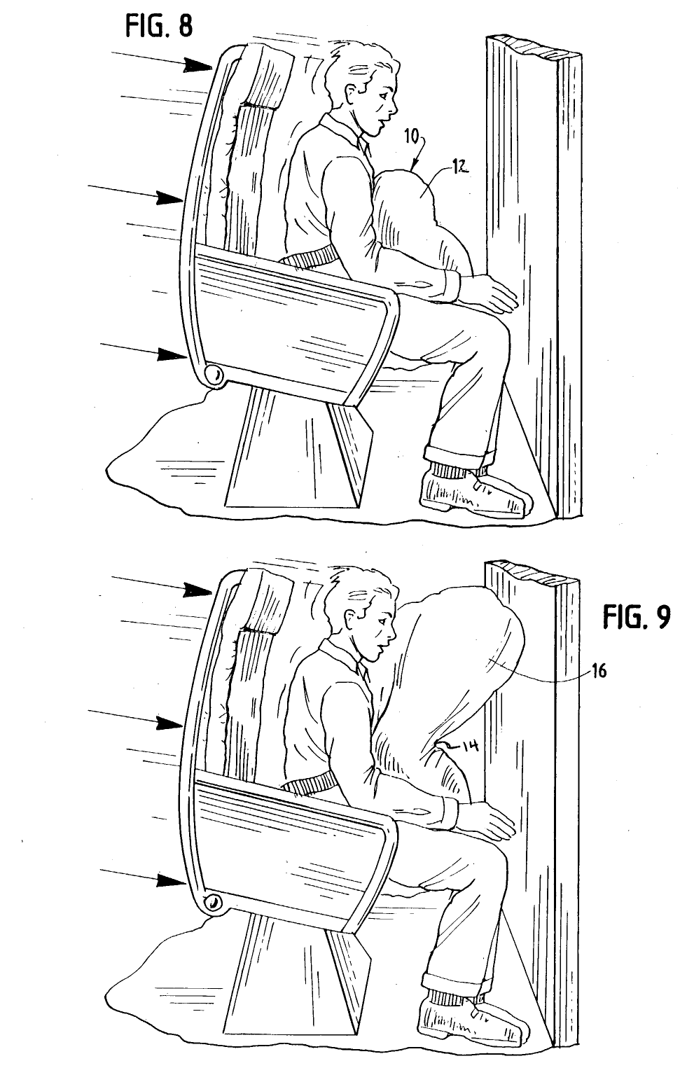

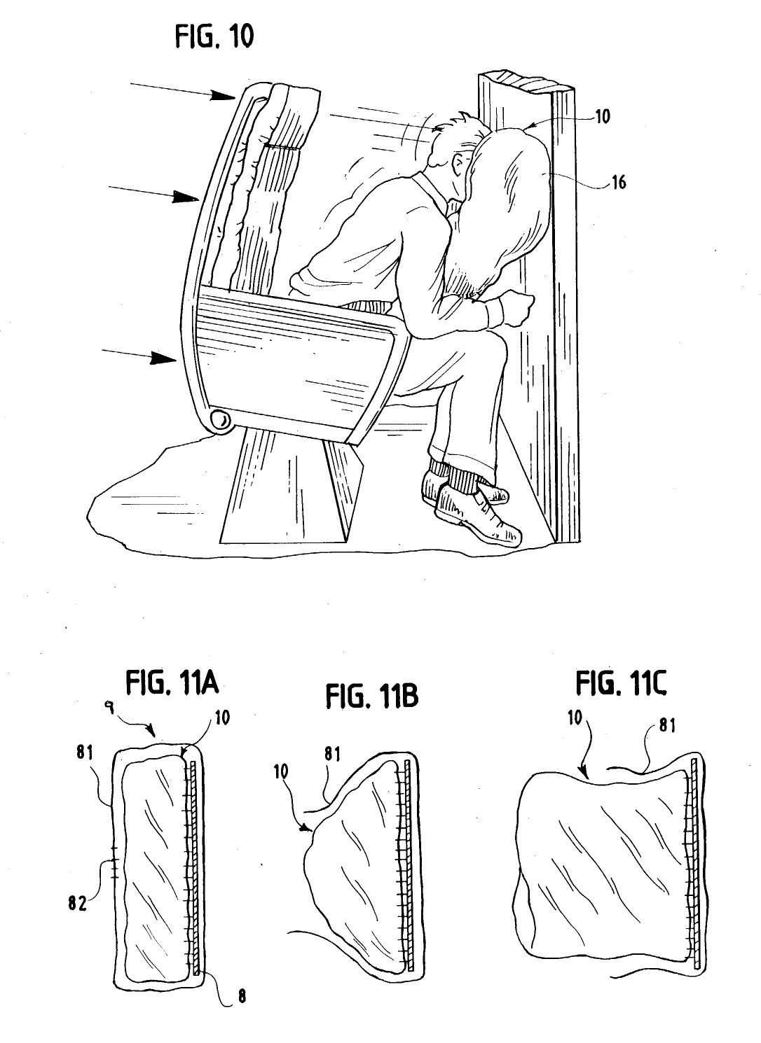

An embodiment of the present invention in use is shown in FIGS. 6-10. FIGS. 6-10 depict stages of deployment during a rapid deceleration event. In FIG. 6, at time t=0, i.e., just before impact, the bag is still housed on the lap belt 8 and covered by a material wrap 81 to create a lap belt housing 9 (see FIGS. 11A-C). Immediately following impact, in FIG. 7, the first portion 12 inflates through the material wrap 81 of the housing 9 and inflates in the zone of the user's abdomen. Depending upon the speed the vehicle was traveling, the stage depicted in FIG. 7 may occur at t=60 to 80 milliseconds, but typically at t equals approximately 70 milliseconds. In FIG. 8, the user has begun to rotate and translate forward, and his abdomen interacts with the inflated portion 12. In FIG. 9, the user's interaction with the first portion 12, coupled with continued inflation from the inflation source, leads to inflation of the second portion 16. The stage depicted in FIG. 9 may occur at t=110 to 130 milliseconds, but typically at t equals approximately 120 milliseconds. By FIG. 10, at approximately t=140 milliseconds, the air bag 10 is fully deployed. Second portion 16 is fully inflated and prevents the user's head from striking a hard surface. The above noted time intervals are for example reference only, and considerably different time intervals may exist depending on different vehicle installation designs.

Thus, the invention provides for a single chamber air bag that acts as two chambers by controlling inflation sequence and occupant interaction with the bag. In the first action, the first portion of the bag 12 acts against the user's abdomen to reduce or limit torso action during a rapid deceleration event. The second action is provided by inflation of the second portion of the bag 16 to act against the neck and head to reduce injuries to those areas. Interaction of the user with the air bag during a rapid deceleration event causes a precisely timed transition of air pressure from the first portion 12 to the second portion 16, leading to, preferably, more uniform energy absorption. In particular, torso interaction with the first portion 12 of the bag contributes to a secondary event that inflates the second portion 16 for minimizing head and neck injuries. Torso restraint prior to head contact with interior vehicle structures (such as, for example, windshields, seats or other walls or panels) reduces the energy component of the head impact resulting in improved overall protection. Energy absorption is provided in two stages with a single air bag.

It will be apparent to those skilled in the art that various modifications and variations can be made in the method and system of the present invention without departing from the spirit or scope of the invention. Thus, it is intended that the present invention include modifications and variations that are within the scope of the appended claims and their equivalents.

What is claimed is:

1. An inflatable lap belt safety bag comprising a first inflatable end, an intermediate section and a second inflatable end, wherein the intermediate section has a reduced cross section relative to the first and second inflatable ends to limit inflation of the second inflatable end until after inflation of the first inflatable end.

2. The inflatable lap belt safety bag of claim 1, further comprising an internal webbing in the intermediate section.

3. The inflatable lap belt safety bag of claim 1, wherein inflation of the second inflatable end is supplemented by air pushed from the first inflatable end into the second inflatable end by a user colliding with the first inflatable end.

4. The inflatable lap belt safety bag of claim 1 wherein the bag is connected to an air source.

5. The inflatable lap belt safety bag of claim 4 wherein the bag is connected to an air source via a hose.

6. The inflatable lap belt safety bag of claim 4 wherein the air source is coupled to a deceleration event sensor system.

7. An inflatable lap belt safety bag comprising:
a first fabric piece comprising two sides thereof and two ends thereof, wherein the two ends thereof are secured to the lap belt in the vicinity of an inflation source, wherein the first fabric piece is constructed to define a top, bottom, front and rear of the safety bag;
a pair of side fabric pieces attached to opposite sides of the first fabric piece to define a pair of opposite side panels of the safety bag; and
wherein each of the side fabric pieces comprises a first portion, a second portion and an intermediate portion, and wherein the intermediate portion has a smaller width than the first and second portions.

8. The inflatable lap belt safety bag of claim 7, further comprising an internal webbing connecting the front and rear of the safety bag between the intermediate portions.

9. The inflatable lap belt safety bag of claim 7, further comprising an internal webbing connecting the opposite side panels in the area of the top of the safety bag.

10. The inflatable lap belt safety bag of claim 7 wherein the bag is connected to an air source.

11. The inflatable lap belt safety bag of claim 10 wherein the bag is connected to air source via a hose.

12. The inflatable lap belt safety bag of claim 7 wherein the air source is coupled to a deceleration event sensor system.

13. An inflatable lap belt safety bag having a rear side, a front side, a top and a bottom comprising:
a B-shaped air chamber defined by a first inflatable portion adjacent the bottom, an intermediate section, and a second inflatable portion adjacent the top;
wherein the rear side of the safety bag is substantially flat upon inflation and the front side of the safety bag comprises an indentation at the intermediate section such that the intermediate section has a reduced width as compared to the first inflatable portion and the second inflatable portion.

14. The inflatable lap belt safety bag of claim 13 wherein the bag further comprises:
a first fabric piece comprising two sides thereof and two ends thereof, wherein the two ends thereof are secured to the lap belt in the vicinity of an inflation source; and
a pair of side fabric pieces attached to opposite sides of the first fabric piece to define a pair of opposite side panels of the safety bag.

15. The inflatable lap belt safety bag of claim 13, further comprising an internal webbing connecting the front side and rear side of the safety bag in the intermediate section.

16. The inflatable lap belt safety bag of claim 14, further comprising an internal webbing connecting the opposite side panels in the area of the top of the safety bag.

17. The inflatable lap belt safety bag of claim 13 wherein the bag is connected to an air source.

18. The inflatable lap belt safety bag of claim 17 wherein the bag is connected to air source via a hose.

19. The inflatable lap belt safety bag of claim 17 wherein the air source is coupled to a deceleration event sensor system.
